(19) United States
(12) Patent Application Publication
(10) Pub. No.: US 2024/0427294 A1
(43) Pub. Date: Dec. 26, 2024

(54) ELECTRONIC TIMEPIECE

(71) Applicant: Casio Computer Co., Ltd., Tokyo (JP)

(72) Inventors: Yuta SAITO, Tokyo (JP); Tomohiro INABA, Tokyo (JP); Sae UCHIBAYASHI, Tokyo (JP)

(21) Appl. No.: 18/748,947

(22) Filed: Jun. 20, 2024

(30) Foreign Application Priority Data
Jun. 23, 2023 (JP) 2023-103133

(51) Int. Cl. G04D 7/00

(52) U.S. Cl. CPC G04D 7/004

(57) ABSTRACT

Disclosed is an electronic timepiece including: a first light detector and a second light detector that detect external light; a first mechanism that limits an amount of the external light detected by the first light detector; and a second mechanism that limits an amount of the external light detected by the second light detector and has a different structure from a structure of the first mechanism.

### REFERENCE TO RELATED APPLICATIONS

This application is based upon and claims the benefit of priority from the prior Japanese Patent Application No. 2023-103133, filed on Jun. 23, 2023, the entire contents of which are incorporated herein by reference.

### TECHNICAL FIELD

The present disclosure relates to an electronic timepiece.

### DESCRIPTION OF RELATED ART

Conventionally, in a timepiece that displays time and the like by driving a pointing hand to rotate, if the timepiece is affected by a strong magnetic field or subjected to a strong shock and the like, the pointing hand drive system may go wrong, causing the actual position of the hand to deviate from the hand position recognized by the control unit.

In order to detect such deviation of hand position, for example, there is known a timepiece having a hand position detection function, in which through holes that transmit light are provided in a plurality of gears constituting a wheel train mechanism that drives the pointing hand to rotate and rotating in conjunction with the pointing hand, and the state in which these through holes overlap at a predetermined position is detected by various light-receiving elements or the like to confirm that the hand is arranged at a specific time position.

Generally, hand position detection is performed by detecting light from a light source in a device such as a timepiece, such as an LED, but there are also known technologies that use external light (natural light) for hand position detection, as described, for example, in JP 2010-066054 A.

### SUMMARY OF THE INVENTION

An electronic timepiece according to an aspect of the present disclosure is an electronic timepiece including: a first light detector and a second light detector that detect external light; a first mechanism that limits an amount of the external light detected by the first light detector; and a second mechanism that limits an amount of the external light detected by the second light detector and has a different structure from a structure of the first mechanism.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a schematic front view of a timepiece according to an embodiment;

FIG. 2 is a schematic main part sectional view of the relationship between a wheel train mechanism and a board and a detector when a light-transmitting portion of hand position detection is in a through state;

FIG. 3 is a schematic main part sectional view of the relationship between the board and a reference illuminance detector in the embodiment;

FIG. 4 is a main part plan view of an example of the reference illuminance detector;

FIG. 5 is a main part plan view showing an example of a through hole corresponding to the reference illuminance detector shown in FIG. 4;

FIG. 6 is a schematic main part sectional view of the relationship between the through hole shown in FIG. 5 and the reference illuminance detector shown in FIG. 4;

FIG. 7 is a schematic main part sectional view of the relationship between the board and the reference illuminance detector when a through hole of the same size as the through hole for hand position detection is provided;

FIG. 8 is a main part sectional view schematically showing the relationship between the reference illuminance detector and the board and the like in a modification example;

FIG. 9 shows a schematic front view of the timepiece showing the positional relationship between the movement range of each hand and the reference illuminance detector; and

FIG. 10 is a plan view of a modification example of the pointing hand.

### DETAILED DESCRIPTION

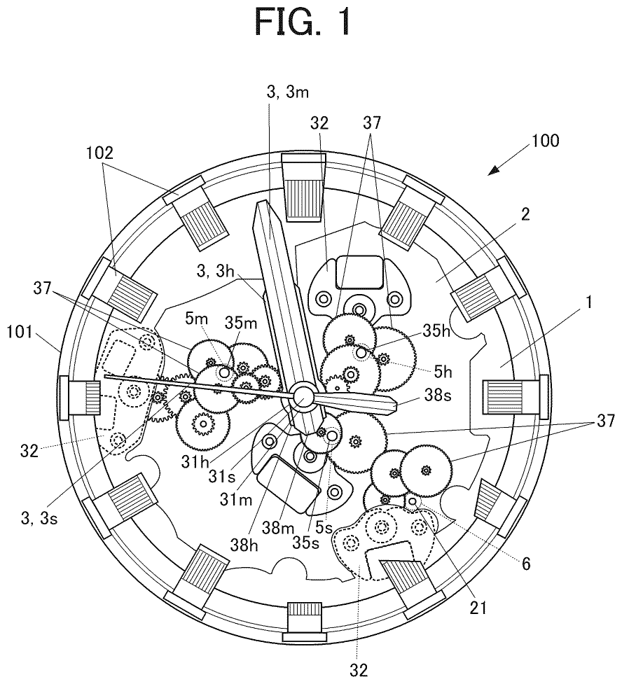

Referring to FIGS. 1 through 7 and the like, an embodiment of an electronic timepiece according to the present disclosure (in the following embodiments, simply referred to as “timepiece 100”) is described below.

The embodiments described below are subject to various technically preferred limitations in order to implement the present disclosure, but the scope of the present disclosure is not limited to the following embodiments and illustrated examples.

### Composition

FIG. 1 is a main part front view showing the main part external view of the timepiece in the embodiment. Note that FIG. 1 is a schematic illustration of each component and does not show the exact arrangement of each part.

As shown in FIG. 1, the timepiece 100 of this embodiment includes a plurality of pointing hands (hereinafter simply referred to as “hands 3”). The timepiece 100 is an analog type timepiece that displays the time by, for example, causing the hands 3 (second hand 3s, minute hand 3m, and hour hand 3h, described below) to point to hour characters 102 arranged along the circumference of the timepiece 100 as appropriate. When simply referring to “hands 3” below, it includes the second hand 3s, the minute hand 3m, and the hour hand 3h.

As shown in FIG. 1, among the hands 3, the second hand 3s is the longest, followed by the minute hand 3m, and the hour hand 3h is the shortest in the embodiment. Among the three hands, the second hand 3s is the thinnest, while the minute hand 3m and the hour hand 3h are relatively wide. The portions behind hand shafts 31s, 31m, 31h in the three hands 3 are referred to as tails 38s, 38m, 38h, respectively, in FIG. 1.

The plurality of hands 3 (second hand 3s, minute hand 3m, hour hand 3h) are mounted on the hand shafts 31s, 31m, and 31h, respectively. The hand shafts 31s, 31m, 31h are shafts that share a common center of rotation and are driven to rotate around their axes by drive mechanisms assembled to a main plate 1, a board 2 and the like, which are the base plate. The board 2 is, for example, a wheel train holder.

Each drive mechanism includes a motor 32 and a wheel train mechanism that transmits the drive power of the motor 32 to the hand 3 (hand shaft 31s, 31m, 31h to which the hand 3 is attached). The wheel train mechanism includes a plurality of gears 37. All or part of the motor 32 and the gears 37 constituting the drive mechanism are arranged above the board 2 (visible side). In this embodiment, at least the board 2 and the gears 37 are formed of a metal material that does not transmit light or a non-transparent resin material.

In order to prevent external light and the like from oblique angles as much as possible from reaching the interior (especially the hand position detector 5 and reference illuminance detector 6 described below), the board 2, gears 37 and the like are preferably arranged so that there are as few gaps between them as possible when they are mounted.

Each hand 3 has its own independent drive mechanism, and each hand shaft 31s, 31m, and 31h rotates separately for each of the hands 3 (second hand 3s, minute hand 3m, and hour hand 3h). The three hands 3 may be driven by two motors 32, one to drive the second hand 3s and the other to drive the minute hand 3m and hour hand 3h, for example.

The plurality of hands 3, the drive mechanisms to rotate and drive the hands 3, and the main plate 1, the board 2 and the like are housed in the device case 101.

Although the main plate 1 does not cover the surface side (visible side) in the timepiece in this embodiment, the shape and configuration of the main plate 1 are not limited to the illustrated example. In FIG. 1, parts that are covered by the main plate 1 and not actually visible are indicated by dashed lines.

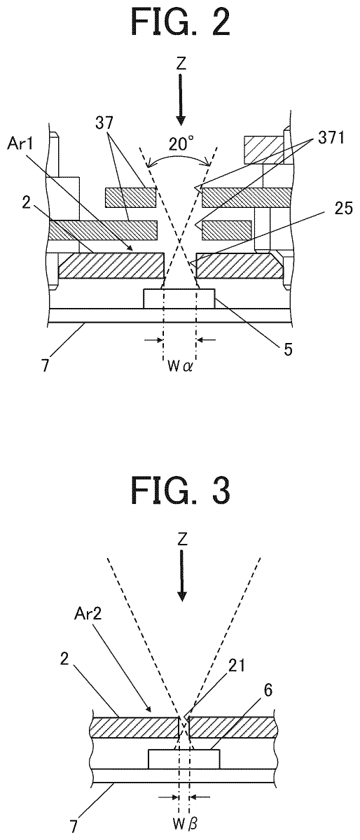

The timepiece 100 of this embodiment has a plurality of hand position detectors 5 (second hand position detector 5s, minute hand position detector 5m, and hour hand position detector 5h) arranged for the respective hands 3 (see FIGS. 1 and 2). When simply referring to “hand position detectors 5” below, these second hand position detector 5s, minute hand position detector 5m, and hour hand position detector 5h are included.

The hand position detectors 5 (second hand position detector 5s, minute hand position detector 5m, hour hand position detector 5h) are composed of phototransistors, for example. The hand position detectors 5 need only be capable of detecting external light and are not limited to phototransistors.

The hand position detectors 5 (second hand position detector 5s, minute hand position detector 5m, hour hand position detector 5h) are “first light detectors” that are arranged below the board 2 and detect external light incident through the “first hole” in the “first area” of the board 2.

FIG. 2 is a main part sectional view schematically showing the relationship between the wheel mechanism and the board and the hand position detector when the light-transmitting portion for detecting the hand position by the hand position detector is in the through state. In FIG. 2 and the like, the direction in which external light is incident on the timepiece 100 from the display side (viewing side) of the timepiece 100 toward the interior of the timepiece 100 is referred to as the “incidence direction Z of external light.

As shown in FIG. 2, a through hole 25, which is a “first hole,” is formed in “first area Ar1” of the board 2. In FIG. 2, the diameter (opening width) of the through hole 25 is defined as “size Wα”.

The hand position detector 5, which is the “first light detector”, is arranged on the lower side than the board 2 (on the lower side in the incidence direction Z of external light) and at a position corresponding to the through hole 25. The hand position detector 5 is arranged on the substrate 7 (see FIG. 2 and the like).

All or part of the gears 37 that constitute the wheel train mechanism corresponding to each hand 3 and that are arranged on the upper side (in the incidence direction z of external light) than the board 2 are provided with through holes (through hole 371 in FIG. 2) that penetrate in the thickness direction of the timepiece 100. Specifically, the through hole 371, which is a “second hole” that allows external light incident on the “first hole” (through hole 25) to pass through, is provided in the gears 37 arranged on the upper side in the incidence direction Z of external light than the hand position detector 5, which is the “first light detector,” and at the position corresponding to the “first area Ar1” of the board 2. The “first area Ar1” is the area around the hand position detector 5, which is the “first light detector,” and corresponds to the gears 37 that constitute the wheel train mechanism corresponding to each hand 3. In this embodiment, each gear 37 with the through hole 371 is a “first non-transparent member” arranged at a position corresponding to the “first area Ar1” of the board 2 and having the through hole 371, which is a “second hole” that allows external light incident on the “first hole” (through hole 25) to pass through.

In other words, as the gear 37 in which the through hole 371 is formed rotates by the drive of the motor 32, the through hole 371 is arranged at a position corresponding to the through hole 25 at a predetermined cycle (i.e., once during one revolution of the hand 3 (one rotation around the timepiece)). This aligns the through hole 371, which is the “second hole” with the through hole 25, which is the “first hole” in the board 2, thus forming the light-transmitting portion 35 (light-transmitting portions 35s, 35m, 35h; see FIG. 1) that penetrates in the thickness direction of the timepiece 100 (incidence direction Z of external light).

Thus, the gear 37 in which the through hole 371 is formed in this embodiment limits the amount of external light detected by the hand position detector 5, which is the “first light detector”. Specifically, the through hole 371 formed in the gear 37 is the “second hole” that allows external light incident on the through hole 25, which is the “first hole,” to pass through, and the gear 37 with the through hole 371 formed is the “first mechanism” in this embodiment.

The hand position detector 5 then detects external light incident through the light-transmitting portion 35 (light-transmitting portion 35s, 35m, 35h) when the light-transmitting portion 35 is formed by the through hole 25, which is the “first hole”, and the through hole 371, which is the “second hole”.

In addition, the timepiece 100 includes a reference illuminance detector 6 in this embodiment.

The reference illuminance detector 6 detects the degree of external light (natural light and the like) at the location where the timepiece 100 is placed. Although the illustration is omitted, in this embodiment, the control unit (CPU) detects the hand position by the hand position detector 5 according to the detection result of the reference illuminance detector 6. Specifically, the control unit (CPU) sets the threshold value for detection by the hand position detector 5 according to the illuminance (illuminance environment) detected by the reference illuminance detector 6.

The reference illuminance detector 6 is a “second light detector” that is arranged on a lower side than the board 2 (on a lower side in the incidence direction Z of external light) and detects external light incident through the “third hole” in the “second area Ar2” of the board 2 (a different area from the “first area Ar1” where the hand position detector 5 is provided). The reference illuminance detector 6 is arranged on a substrate 7 (see FIG. 3 and the like). There may be more than one board 2. For example, the board corresponding to “first area Ar1” and the board corresponding to “second area Ar2” may be separate.

The reference illuminance detector 6 is preferably arranged to avoid, as much as possible, positions directly under the shadow of the hand 3 or positions affected by the shadow. For example, the reference illuminance detector 6 is arranged at a position not blocked above by the hand 3 (second hand 3s, minute hand 3m, hour hand 3h) when the hand 3 is moved to a predetermined time position (such as 12 o'clock position). In addition, as mentioned above, the hour hand 3h is a wide and short-length hand 3, and even when the hour hand 3h is not blocking the upper part of the reference illuminance detector 6, it is likely to cast a wide shadow within its range of rotation (movement range). Furthermore, the hour hand 3h takes the longest time among the three hands 3 to make one rotation and stays in the same position for a long time. For this reason, the reference illuminance detector 6 is preferably arranged at a position outside the movement range from the tip to the tail 38h in the hour hand 3h.

In contrast, the second hand 3s and the minute hand 3m are relatively longer than the hour hand 3h and have a wider movement range, making it difficult to arrange the reference illuminance detector 6 to avoid the entire movement range. Also, compared to the hour hand 3h, it takes less time to complete one revolution and stays in the same place for a shorter period of time. In addition, relatively thin hands are often used, especially for the second hand 3s. Even in that case, however, the tails 38s and 38m of the respective hands are often wide. For this reason, the reference illuminance detector 6 is preferably arranged at least outside the movement range of the tails 38s and 38m of the second hand 3s and the minute hand 3m.

FIG. 3 is a schematic main part sectional view of the relationship between the board and the reference illuminance detector.

As shown in FIG. 3, a through hole 21, which is a “third hole”, is formed in the “second area Ar2” of the board 2.

The reference illuminance detector 6, which is the “second light detector,” is arranged on the lower side than the board 2 (on the lower side in the incidence direction z of external light) and at a position corresponding to the through hole 21.

As shown in FIG. 1, the “second area Ar2” corresponding to the reference illuminance detector 6 on the board 2 does not have a configuration that can take a through state and a non-through state by moving the gear 37, which is a “predetermined operating member”, such as light-transmitting portions 35 (35s, 35m, 35h) corresponding to the hand position detectors 5 (second hand position detector 5s, minute hand position detector 5m, hour hand position detector 5h). Therefore, the through hole 21, which is the “third hole,” functions as an opening that always penetrates to let in external light.

The reference illuminance detector 6 consists of a phototransistor, for example. The reference illuminance detector 6 can detect external light and is not limited to phototransistors.

In this embodiment, the through hole 21 in the board 2, which is the “third hole,” is a mechanism that limits the amount of external light detected by the reference illuminance detector 6, which is the “second light detector,” and is a “second mechanism” having a different structure from the “first mechanism” consisting of the gears 37. In other words, the through hole 21, which is the “third hole,” is smaller than the through hole 25, which is the “first hole” corresponding to the hand position detector 5.

Specifically, as shown in FIG. 3, the diameter (opening width) of the through hole 21 is “size Wβ”. The “size Wβ” is smaller than the “size Wα” of the through hole 25, which is the “first hole” shown in FIG. 2. The degree of “size Wα” of the through hole 25 and the degree of difference by which the “size Wβ” of the through hole 21 is smaller than the “size Wα” may be set as desired. In this embodiment, by making the “size Wβ” of the through hole 21 smaller, the amount of external light that passes through the through hole 21 and is detected by the reference illuminance detector 6 is limited.

If the reference illuminance detector 6 has a non-detection portion 65 having electrodes and the like arranged in the center and not detecting light, as shown in FIG. 4, it may not be able to sufficiently detect light when the diameter (opening width) of the through hole 21 is narrowed to “size Wβ”.

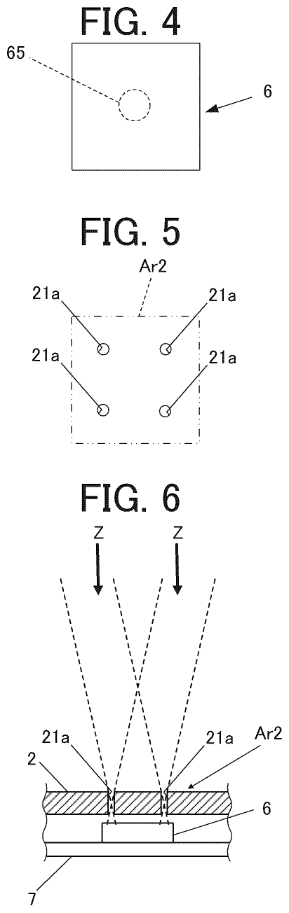

For this reason, for example, as shown in FIG. 5, as a “third hole” provided in the “second area Ar2” corresponding to the reference illuminance detector 6, plurality of through holes 21a (four in the illustrated example) smaller than the “size Wα” of the through hole 25 may be provided at a position that does not overlap with the non-detection portion 65 when viewed from the viewing direction (incidence direction Z of external light) of the timepiece 100. In that case, at least two of the plurality of through holes 21a are provided at positions that are point symmetrical from the position corresponding to the center position of the non-detection portion 65. FIG. 6 is a main part cross-sectional view schematically showing the relationship between the through holes shown in FIG. 5 and the reference illuminance detector shown in FIG. 4.

In this case, the amount of external light incident through the plurality of through holes 21a is preferably approximately a degree balanced by the amount of external light incident through the through hole 25, which is the “first hole”.

When providing a plurality of through holes 21a in this manner, the through holes 21a is preferably provided so as to avoid the non-detection portion 65 to the extent that they are not too close to the edge of the reference illuminance detector 6 and surround the non-detection portion 65. The arrangement and number of through holes 21a are not limited to the illustrated example.

The through hole 21 or through hole 21a as the “third hole” preferably include a structure to suppress light reflection on the inner surface of the through hole 21 or through hole 21a by making the inner surface black or by forming the entire board 2 or at least the area around the through hole 21 or through hole 21a with a black material. The same structure may be included on the inner surface of the through hole 35 corresponding to the hand position detector 5. The method of making the inner side of through hole 21 and the like black is not particularly limited. For example, it may be plated black by various methods or painted with black paint.

This can suppress the light reflected on the inner surface of the through hole 21 and the like. The color of the inner surface of the through hole 21 and the like is not limited to “black”. Any color other than black that can suppress the reflection of light is acceptable.

When using external light (natural light) for hand position detection, it is preferable to detect only light incident perpendicular to the display surface (viewing side surface) of the timepiece as much as possible with the hand position detector 5 and reference illuminance detector 6 in order to obtain accurate detection results.

In this regard, as shown in FIG. 2, when the light incident on the through hole 25, which is the “first hole,” is narrowed down by the through hole 371, which is the “second hole,” of the gear 37, which is the “first non-transparent member” arranged on the upper side in the incidence direction Z of external light than the board 2, the spread of light (external light) incident on the hand position detector 5 through the through hole 25, which is the “first hole,” and the through hole 371, which is the “second hole,” is about 20 degrees. Therefore, the light incident on the hand position detector 5 through the through hole 25 and through hole 371 can be narrowed down to be the light (external light) incident almost perpendicular to the display surface (viewing side surface) of the timepiece 100, and light incident from oblique angles can be prevented.

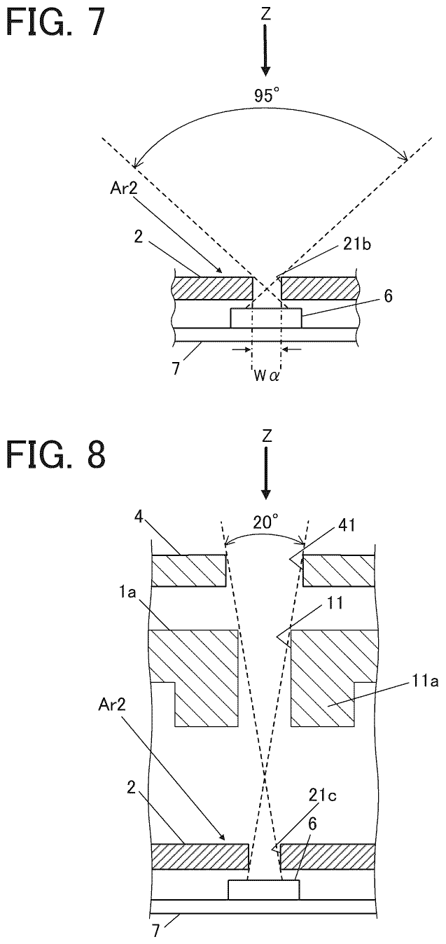

In contrast, FIG. 7 is a main part sectional view schematically showing the relationship between the board and the reference illuminance detector when a through hole with a diameter (opening width) equivalent to the through hole 25 (i.e., “size Wα”) is provided in the “second area Ar2” corresponding to the reference illuminance detector 6.

As shown in FIG. 7, in this case, unlike the case of the through hole 25 shown in FIG. 2, there is nothing to narrow the light incident on the through hole 21b. Therefore, the spread of light (external light) that passes through the through hole 21b and is incident on the reference illuminance detector 6 is about 95 degrees, and light (external light) is incident on the reference illuminance detector 6 from all directions, including from oblique angles.

In this condition where light (external light) is incident from all directions, the degree of external light (illuminance environment) as a result of detection by the reference illuminance detector 6 becomes too high, and the control unit (CPU) cannot set the threshold value for detection by the hand position detector 5 to an appropriate value.

In this respect, as shown in FIG. 3, FIG. 6 and the like, when the “third hole” is a hole smaller than the through hole 25, such as through hole 21 or through hole 21a, the incidence of light other than that incident perpendicular to the display surface (viewing side surface) of the timepiece 100 can be suppressed as much as possible and the reference illuminance detector 6 can obtain appropriate detection results.

### Action

Next, the action of the timepiece 100 of this embodiment will be described in detail, especially with respect to the method of detecting the position of the hands.

When performing hand position detection, first, all hands 3 (second hand 3s, minute hand 3m, and hour hand 3h) are moved to the 12 o'clock position. It is sufficient if all the hands 3 are arranged at the same position, and not necessarily at 12 o'clock position.

In this embodiment, the reference illuminance detector 6 is arranged in a position where it is not blocked above by the hands 3 when all these hands 3 are arranged at the same position. Before the hand position detection is performed, the reference illuminance detector 6 measures (detects) external light incident through the through hole 21, which is the “third hole”. At this time, the upper side of the reference illuminance detector 6 (the upper side in the incidence direction Z of external light) is not blocked by the hand 3, thus, the detection operation is not disturbed.

The detection results by the reference illuminance detector 6 are obtained by the control unit (CPU), which determines whether the illuminance is too high or too low to be suitable for hand position detection from the detection result of the reference illuminance detector 6. For example, if the location where the timepiece 100 is placed is a dark room and the like, it is difficult to obtain the illuminance necessary to obtain accurate (reliable) detection results since sufficient external light is not available. Conversely, if the timepiece 100 is located outdoors on a sunny day, external light may be incident on the timepiece 100 even through a small gap other than the light-transmitting portion 35, which is in a through state, and the light-transmitting portion 35 may detect a high illuminance of external light even when the light-transmitting portion 35 is not in a through state. In this case as well, accurate (reliable) detection results cannot be obtained.

The environment in which good hand position detection can be performed is considered to be when the external environment in which the timepiece 100 is arranged has an illuminance level of 500 Lx or higher to about 50000 Lx.

Therefore, the control unit (CPU) determines that the illuminance is too high to be suitable for hand position detection if the illuminance detected by the reference illuminance detector 6 exceeds, for example, 50000 Lx, and that the illuminance is too low to be suitable for hand position detection if it is less than 500 Lx.

If the control unit (CPU) determines from the detection results of the reference illuminance detector 6 that the illuminance is neither too high nor too low to be suitable for hand position detection, the control unit (CPU) sets the threshold for detection by the hand position detector 5 according to the detected illuminance.

For example, if the detected illuminance is low, a low threshold is set to detect that external light is incident even at relatively low illuminance. If the detected illuminance is relatively high, for example, a high threshold is set to detect that external light is incident when a certain level of high illuminance is detected. The threshold may be set in any number of levels. For example, the threshold may be set at three levels: low illuminance (e.g., 500 Lx to less than 2000 Lx), high illuminance (e.g., 10000 Lx to about 50000 Lx), and medium illuminance (e.g., 2000 Lx to less than 10000 Lx), or the threshold level may be further divided finely.

When the threshold level is severe (i.e., when a high threshold is set), there is a possibility that the presence of incident light is not detected even when external light is actually incident. Conversely, if the threshold level is low (i.e., a low threshold is set), external light exceeding the threshold may be detected even when the light-transmitting portion 35 is not in a through state and should not be judged to have detected external light above the threshold value. Although the level of the threshold setting is a matter to be determined as appropriate, for example, the threshold is preferably set low at the beginning, and when external light above the threshold is not detected properly, the threshold level is preferably modified and re-set in a severer direction as described below.

In this embodiment, the size of the through hole 21, which is the “third hole” corresponding to the reference illuminance detector 6, is made small so that the reference illuminance detector 6 can obtain appropriate detection results, and light of the approximately same amount as external light detected in the hand position detector 5 is incident through the through hole 21, which is the “third hole”. Therefore, the reference illuminance detector 6 detects external light under the same conditions as the detection conditions in the hand position detector 5, and the illuminance environment can be correctly determined.

This allows highly reliable detection results to be obtained even when hand position detection is performed by external light without the use of LEDs or other devices. It also minimizes the need to re-set the threshold level. When using external light (natural light) to detect the position of the hands, it is desirable to use a light receiving element or other detection means to detect only light incident perpendicular to the display surface (viewing side) of the timepiece as much as possible in order to obtain accurate detection results. It is also desirable to detect the illuminance environment inside the device and perform hand position detection according to the detection results, and it is also desirable to detect the illuminance environment by detecting only light incident perpendicularly as much as possible.

However, conventional timepieces (e.g., the timepiece described in JP 2010-066054) are not provided with a means to prevent light incident from oblique angles. Therefore, it was difficult to perform highly accurate hand position detection according to the illuminance environment.

In this regard, according to this embodiment, as described above, an electronic timepiece includes: the hand position detector 5, which is the “first light detector” and the reference illuminance detector 6, which is the “second light detector” that detect external light; the gear 37 as the “first mechanism” that limits the amount of external light detected by the hand position detector 5; and the through hole 21 (in this embodiment, the through hole 21 is smaller than the through hole 25) as the “second mechanism” that limits the amount of external light detected by the reference illuminance detector 6 and has a different structure from the “first mechanism”.

As a result, even when hand position detection is performed by external light, the reference illuminance detector 6 detects external light under the same conditions as the detection conditions in the hand position detector 5 to correctly determine the illuminance environment. Therefore, highly reliable detection results can be obtained.

Specifically, the timepiece 100 in this embodiment includes: the board 2; the hand position detector 5 as the “first light detector” that is arranged on the lower side than the board 2 (lower side in the incidence direction of external light) and detects external light incident through the through hole 25, which is the “first hole” in the “first area Ar1” of the board 2; the gear 37, which is the “first non-transparent member” arranged at a position that is upper in the incidence direction Z of external light than the hand position detector 5 and that corresponds to the “first area Ar1” of the board 2 and having the through hole 371 which is the “second hole” that allows external light incident on the through hole 25 which is the “first hole” to pass through; and the reference illuminance detector 6 as a “second light detector” that is arranged on a lower side in the incidence direction Z of external light than the board 2 and detects external light incident through the through hole 21, which is a “third hole” in the “second area Ar2” of the board 2. The through hole 21, which is the “third hole,” is formed to be smaller (Wα>Wβ) than the through hole 25, which is the “first hole”.

With this configuration, light of approximately the same amount as external light detected in the hand position detector 5 is incident through the through hole 21, which is the “third hole”. Therefore, the reference illuminance detector 6 detects external light under the same conditions as the detection conditions in the hand position detector 5, and the illuminance environment can be correctly determined.

This allows highly reliable detection results to be obtained even when hand position detection is performed by external light without the use of LEDs or other devices. It also minimizes the need to re-set the threshold level.

The “third hole” that allows external light incident on the reference illuminance detector 6, which is the “second light detector”, to pass through may consist of a plurality of through holes 21a, which are smaller in diameter than the through hole 25, which is the “first hole”.

In this case, even when there is a non-detection portion 65 in the center of the reference illuminance detector 6 or the like, external light can be incident avoiding the non-detection portion 65, and the size of the “third hole” can be made smaller than the “first hole,” the through hole 25, to narrow external light, while still ensuring sufficient light amount for detection.

The board 2 in this embodiment is a wheel train holder in which a drive mechanism, such as a wheel train mechanism, is assembled.

Therefore, the through hole 25, which is the “first hole”, and the through hole 21, which is the “third hole”, can be formed using the components originally provided in the timepiece 100.

Therefore, this configuration can be realized without increasing the number of components.

In this embodiment, at least the through hole 21, through hole 21a, which is the “third hole,” preferably includes a structure that suppresses light reflection on its inner surface. The structure to suppress light reflection includes, specifically, plating the inner surface with black or other color, painting the inner surface with black or other color paint, or forming the members around the through hole 21 and through hole 21a with black or other materials that do not reflect light.

This suppresses the reflection of light on the inner surface of the through hole 21 and through hole 21a and its incidence on the reference illuminance detector 6.

The reference illuminance detector 6 as the “second light detector” of this embodiment is arranged in a position that is not blocked above by the hand 3 when the hand 3 is moved to a predetermined time position (e.g., 12 o'clock).

This allows the reference illuminance detector 6 to be arranged at a position that is not in the shadow of the hand 3 or not affected by the shadow as much as possible, thus avoiding a situation where external light cannot be detected due to the shadow of the hand 3.

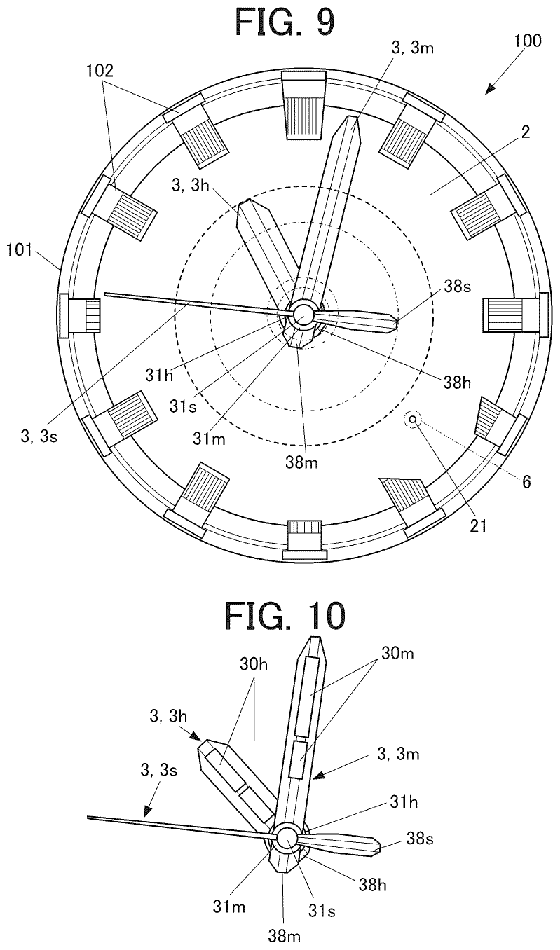

FIG. 9 is a schematic front view of the timepiece that schematically shows the movement range of the hour hand from its tip to its tail, as well as the movement ranges of the tails of the second and minute hands. In FIG. 9, the movement range of the tip of the hour hand 3h is shown by a thick dashed line, and the movement range of the tail 38h of the hour hand 3h is shown by a thin dashed line. The movement range of the tail 38m of the minute hand 3m is shown by a double-dashed line, and the movement range of the tail 38s of the second hand 3s is shown by a single-dashed line. In FIG. 9, the illustrations of each hand 3 (second hand 3s, minute hand 3m, and hour hand 3h) and the components of the timepiece 100 other than the device case 101 and hour characters 102 are omitted.

The timepiece 100 in this embodiment includes a second hand 3s, a minute hand 3m, and an hour hand 3h that are driven to rotate around the hand shafts 31s, 31m, 31h. As shown in FIG. 9, the reference illuminance detector 6 as the “second light detector” is arranged on an outer side than the movement range from the tip to the tail 38h in the hour hand 3h, and also on an outer side than the movement ranges of the tails 38s and 38m in the second hand 3s and the minute hand 3m.

This minimizes the effect of the hour hand 3h, which is particularly wide and stays in the same position for a long time.

In many cases, the tails 38s and 38m are wide even for the second hand 3s and the minute hand 3m, which are often relatively thin. In this respect, arranging the reference illuminance detector 6 on an outer side than the movement ranges of the tails 38s and 38m prevents it from being hidden under the tails 38s and 38m or prevents disturbance of detecting external light by the shadow of the tails 38s and 38m.

As described above, if the influence of the shadow of hand 3 is minimized by devising ways to avoid the influence of the shadow of hand 3, the software design load that should take the influence of the shadow of hand 3 into account is reduced. Also, by optimizing the detection results of the reference illuminance detector 6, an appropriate threshold value can be set for hand position detection, allowing hand position detection to be completed in the shortest possible time, reducing the burden on the user.

### Modification Example

Although the embodiments of the present disclosure have been described above, it goes without saying that the present disclosure is not limited to such embodiments and can be varied in various ways to the extent that it does not depart from the gist thereof.

For example, as shown in FIG. 8, a through hole 21c, which is the “third hole,” is provided in the “second area Ar2” of the board 2, and through holes 41 and 11, which are the “fourth holes” that allow external light incident on this through hole 21c to pass through, are provided in the “second non-transparent member”. Then, the reference illuminance detector 6 as the “second light detector” is provided to be arranged on the lower side in the incidence direction Z of external light than the board 2 and the “second non-transparent member”, and detect external light incident through the through hole 21c, which is the “third hole”, and through holes 41 and 11, which are the “fourth holes”. The structure is made such that the amount of external light incident on the hand position detector 5, which is the “first light detector,” through the through hole 25, which is the “first hole,” and the through hole 371, which is the “second hole,” is substantially equivalent to the amount of external light incident on the reference illuminance detector 6 as the “second light detector” through the through hole 21c, which is the “third hole,” and the through holes 41, 11, which are the “fourth holes”.

The “second non-transparent member” is, for example, the date wheel holder 4 or the main plate 1a shown in FIG. 8. The “second non-transparent member” may be any other member, and the “second non-transparent member” to which the “fourth hole” is provided may be only one of the date wheel holder 4 or the main plate 1a, or three or more members including other members.

In this case, the light incident on the through hole 21c, which is the “third hole” in the board 2, can be narrowed by the through holes 41 and 11, which are the “fourth holes” provided in the date wheel holder 4 and the main plate 1a, which are the “second non-transparent members” arranged on the upper side than the board 2 in the incidence direction Z.

In this case, the through holes 41 and 11, which are the “fourth holes” provided in the date wheel holder 4 and the main plate 1a, which are the “second non-transparent members,” are mechanisms that limit the amount of external light detected by the reference illuminance detector 6, and constitute a “second mechanism” that has a different structure from the “first mechanism”.

With this configuration, even when the size of the through hole 21c, which is the “third hole,” is the same as that of the through hole 25, which is the “first hole,” the spread of the light (external light) incident on the reference illuminance detector 6 through the through hole 21c, which is the “third hole,” and through holes 41 and 11, which are the “fourth holes,” is about 20 degrees, similar to the spread of external light incident on the hand position detector 5, which is the “first light detector,” as shown in FIG. 8.

This allows the light incident on the reference illuminance detector 6 through the through holes 21c and 41, 11 to be narrowed down so that almost all the light is the light (external light) incident perpendicular to the display surface (viewing side surface) of the timepiece 100, preventing light incident from oblique angles, and making the light amount equal to the amount of light incident on the hand position detector 5.

Also in this case, at least the through hole 21c, which is the “third hole”, and the through holes 41 and 11, which are the “fourth holes”, preferably include a structure to suppress light reflection on their inner surfaces. The structure to suppress reflection of light is the same as that described above for the through holes 21 and the like.

This suppresses the reflection of light on the inner surfaces of the through holes 21c, 41, and 11 and the incidence of light on the reference illuminance detector 6.

In this case, the perimeter of the through holes 41 and 11, which are the “fourth holes” in the date wheel holder 4 and the main plate 1a, which are the “second non-transparent members” arranged on the upper side in the incidence direction Z of external light of the reference illuminance detector 6 as the “second light detector”, may be thick-walled. In FIG. 8, the perimeter of the through holes 11 is a thick-walled portion 11a. A thick-walled portion may also be provided around the through hole 41.

This makes it more difficult for light from oblique angles to be incident on the “fourth hole” and the through hole 21c, which is the “third hole” arranged below it, and is expected to allow proper detection of external light by the reference illuminance detector 6.

For example, when including hands 3 that rotate and drive around hand shafts 31s, 31m, and 31h as in the above embodiment, at least the minute hand 3m and the hour hand 3h may be provided with light-transmitting portions that transmit light.

FIG. 10 is a main part plan view showing an example of a hand 3 with a light-transmitting portion.

As shown in FIG. 10, in this case, the minute hand 3m and the hour hand 3h are partially or entirely made of light-transmitting portions 30m and 30h such that light is transmitted through them.

The light-transmitting portions 30m and 30h may be notches or light-transmitting portions formed of transparent resin members or the like. When formed of a transparent resin member and the like, the entire hand 3 or at least the portion that affects the detection of external light by the reference illuminance detector 6 may be configured as a widely transparent light-transmitting portion.

When the light-transmitting portions 30m and 30h are provided partially or entirely for the minute hand 3m and hour hand 3h, even when the hand 3 is arranged above the reference illuminance detector 6 as the “second light detector” (above in the incidence direction Z of external light), detection of external light is not disturbed and stable external light detection is possible.

Although some embodiments of the present disclosure have been described above, the scope of the present disclosure is not limited to the embodiments described above, but includes the scope of the invention described in the claims and its equivalents.

1. An electronic timepiece comprising:
a first light detector and a second light detector that detect external light;
a first mechanism that limits an amount of the external light detected by the first light detector; and
a second mechanism that limits an amount of the external light detected by the second light detector and has a different structure from a structure of the first mechanism.

2. The electronic timepiece according to claim 1, further comprising:
a board in which a first hole is provided in a first area and a third hole is provided in a second area; and
a first non-transparent member arranged at a position corresponding to the first area of the board, and having a second hole that allows external light incident on the first hole to pass through, wherein
the first light detector is arranged on a lower side in an incidence direction of the external light than the board and the first non-transparent member, and detects external light incident through the first hole provided in the first area of the board,
the second light detector is arranged on a lower side in the incidence direction of the external light than the board, and detects external light incident through the third hole provided in the second area of the board, and
the third hole is formed to be smaller than the first hole.

3. The electronic timepiece according to claim 1, further comprising:
a board in which a first hole is provided in a first area and a third hole is provided in a second area;
a first non-transparent member arranged at a position corresponding to the first area of the board, and having a second hole that allows external light incident on the first hole to pass through; and
a second non-transparent member having a fourth hole that allows external light incident on the third hole to pass through, the third hole being provided in the second area of the board, wherein
the first light detector is arranged on a lower side in an incidence direction of the external light than the board and the first non-transparent member, and detects external light incident through the first hole provided in the first area of the board,
the second light detector is arranged on a lower side in the incidence direction of the external light than the board and the second non-transparent member, and detects external light incident through the third hole provided in the second area of the board, and
the second hole and the fourth hole are formed to have such a size that an amount of external light incident on the first light detector through the first hole and the second hole is substantially equal to an amount of external light incident on the second light detector through the third hole and the fourth hole.

4. The electronic timepiece according to claim 2, wherein the third hole that allows the external light incident on the second light detector to pass through includes a plurality of holes being smaller in diameter than the first hole.

5. The electronic timepiece according to claim 2, wherein, in at least the third hole, an inner surface of the third hole is formed in a color that suppresses reflection of light.

6. The electronic timepiece according to claim 3, wherein, in at least the third hole, an inner surface of the third hole is formed in a color that suppresses reflection of light.

7. The electronic timepiece according to claim 2, wherein the board is a wheel train holder.

8. The electronic timepiece according to claim 3, wherein the board is a wheel train holder.

9. The electronic timepiece according to claim 3, wherein a perimeter of the fourth hole in the second non-transparent member arranged on an upper side of the second light detector is a thick-walled portion.

10. The electronic timepiece according to claim 1, wherein the second light detector is arranged at a position not blocked above by a hand that is moved to a predetermined time position.

11. The electronic timepiece according to claim 1, further comprising an hour hand that is driven to rotate around a shaft, wherein
the second light detector is arranged on an outer side than a movement range of a tip of the hour hand.

12. The electronic timepiece according to claim 1, further comprising a second hand, a minute hand, and an hour hand that are driven to rotate around a shaft, wherein
the second light detector is arranged on an outer side than a movement range of tails of the second hand, the minute hand, and the hour hand.

13. The electronic timepiece according to claim 1, further comprising a minute hand and an hour hand that are driven to rotate around a shaft, wherein
a light-transmitting portion that transmits light is provided for the minute hand and the hour hand.

14. The electronic timepiece according to claim 4, wherein
the second light detector has a non-detection area that is not able to detect the external light, and
the plurality of holes smaller in diameter than the first hole are provided at positions not overlapping the non-detection area in a viewing direction of the electronic timepiece.

15. The electronic timepiece according to claim 14, wherein two holes among the plurality of holes smaller in diameter than the first hole are provided at positions that are point symmetrical with respect to a position corresponding to a center of the non-detection area.
